(19) United States
(12) Patent Application Publication
(10) Pub. No.: US 2025/0241455 A1
(43) Pub. Date: Jul. 31, 2025

(54) FASTENING MEMBER FOR QUICK RELEASE AND FASTENING OF HIGH CHAIR LEG

(71) Applicant: PAO-HSIEN CHENG, TAIPEI CITY (TW)

(72) Inventor: PAO-HSIEN CHENG, TAIPEI CITY (TW)

(21) Appl. No.: 19/010,694

(22) Filed: Jan. 6, 2025

(30) Foreign Application Priority Data
Jan. 26, 2024 (CN) 202420191638.7

(51) Int. Cl. A47D 1/00; F16B 7/18

(52) U.S. Cl. CPC A47D 1/006; F16B 7/187

(57) ABSTRACT

A fastening member for quick release and fastening of a high chair leg is provided. The fastening member is disposed between an upper support tube and a lower support tube of the leg and provided with a sleeve member, a locking hook, a plug, a curved swing arm, and a sliding sleeve. The curved swing arm located inside the plug is connected to the plug by a third pin to be rotatable. The sliding sleeve is mounted around a lower end of the upper support tube. The sliding sleeve is provided with an abutting portion corresponding to an insertion hole and abutting against an upper part of the curved swing arm. By the fastening member, the upper support tube and the lower support tube are separated from or assembled with each other quickly. The sliding sleeve enables the fastening member to be released from or maintained at a fastened state.

### BACKGROUND OF THE INVENTION

### Field of the Invention

The present invention relates to high chair legs, especially to a fastening member for quick release and fastening of high chair legs.

### Description of Related Art

A high chair is used for feeding babies, toddlers, or children and raised a fair distance from the ground to allow them to be at the same level as adults during mealtimes. In a conventional assembled high chair, each of high chair legs is divided into an upper segment and a lower segment connected to each other by a fastening mechanism. By the fastening mechanism in a fastened state or released state, the upper segment and the lower segment of the leg are connected or separated from each other. The conventional fastening mechanism is directly exposed so that it's easy to be released from the fastened state due to unintended touches. Thus the upper segment and the lower segment of the leg may be separated from each other and this causes a safety issue while in use.

### SUMMARY OF THE INVENTION

Therefore, it is a primary object of the present invention to provide a fastening member for quick release and fastening of legs of a high chair for solving the above problems.

In order to achieve the above object, a fastening member for quick release and fastening of legs of a high chair according to the present invention is provided.

The high chair includes a seat portion and four legs connected to four corners of the seat portion correspondingly. Each of the legs consists of an upper support tube, a lower support tube, and a fastening member disposed between the upper support tube and the lower support tube.

The fastening member is provided with a sleeve member, a locking hook, a plug, a curved swing arm, and a sliding sleeve.

The sleeve member is provided with an upper slot and a lower slot separated by a partition and a step disposed on the partition. A bottom end of the plug is inserted in and connected to the upper slot and an upper end of the lower support tube is inserted in and connected to the lower slot.

One end of the locking hook is connected to the upper slot by a first pin and able to rotate. The other end of the locking hook is provided with a hook portion and a middle portion of the locking hook forms a projection which is locked with the step of the partition.

The plug is fixed on a bottom end of the upper support tube by a second pin and provided with an upper opening and a lower opening. Both the upper opening and the lower opening are communicating with an inner space of the plug and the lower opening is corresponding to the hook portion of the locking hook.

The curved swing arm is located in the inner space of the plug. A middle portion of the curved swing arm is connected to the plug by a third pin and able to rotate. An upper part of the curved swing arm is not only corresponding to both an insertion hole penetrating a tube wall of the upper support tube and the upper opening, but also protruding from the insertion hole and the upper opening. A lower part of the curved swing arm is inserted through the lower opening of the plug correspondingly.

The sliding sleeve is mounted around a lower end of the upper support tube and connected to the upper support tube by a reset part in a returnable manner. An abutting portion is projecting from an inner wall of the sliding sleeve, corresponding to the insertion hole, and abutting against the upper part of the curved swing arm.

Preferably, the reset part includes a limit rod and a spring. Two ends of the limit rod are inserted in and disposed on a peripheral wall of the plug and a step-like member on a bottom of the sliding sleeve is reaching into the upper support tube. Thus two ends of the spring are abutting against the limit rod and the step-like member on the bottom of the sliding sleeve correspondingly.

Preferably, the high chair includes a table plate which is located under the seat portion. Each of four corners of the table plate is provided with the sleeve member.

Preferably, a backrest of the seat portion is filled with foamed plastic. Preferably, an anti-slip pad is disposed on a bottom of the lower support tube. Preferably, a through hole is arranged at the lower slot of the sleeve member. A tube wall of the lower support tube is provided with an insertion hole and a U-shaped spring is mounted inside the lower support tube. One end of the U-shaped spring is connected with a projection inserted through the insertion hole and elastically protruding from the tube wall of the lower support tube to be locked in the through hole correspondingly.

Compared with the techniques available now, the present invention has the following advantages.

By the arrangement of the fastening member, the locking hook already fastened is covered by the sliding sleeve and unable to be released from the fastened state due to unintended touches of children or parents when the upper and the lower support tubes are connected. Thus the separation of the upper support tube from the lower support tube which causes safety problems in use of the high chair can be avoided. In order to release the locking hook from the fastened state, the sliding sleeve is pushed by a force applied to move upward and further drive the curved swing arm. Thus the locking hook is further pushed by the curved swing arm to release from the plug on the bottom end of the lower support tube. Thereby the upper support tube and the lower support tube are separated. The operation is quite easy and fast.

### BRIEF DESCRIPTION OF THE DRAWINGS

FIG. 1 is a perspective view of a high chair of an embodiment according to the present invention;

FIG. 2 is a partial sectional view showing an upper support tube and a lower support tube fastened by a fastening member of an embodiment according to the present invention;

FIG. 3 is a partial sectional view showing a sliding sleeve going to be released from a locking hook in a fastening member of an embodiment according to the present invention;

FIG. 4 is a partial sectional view showing an upper support tube separated from a lower support tube of an embodiment according to the present invention; and

FIG. 5 is a partial sectional view showing an upper support tube inserted into an upper slot of a sleeve member of an embodiment according to the present invention.

### DETAILED DESCRIPTION OF THE PREFERRED EMBODIMENT

The present invention is described in detail with reference to the following embodiments combined with figures. In the specification or the figures, the same reference sign is used in the same component or similar components. In applications, shape, thickness, or height of the respective components can be expanded or compressed. The respective embodiments provided in the present invention are only used for to explain technical solutions, not intended to limit the scope of the present invention. Modifications or changes made to the present invention are not departing from spirit and scope of the present invention.

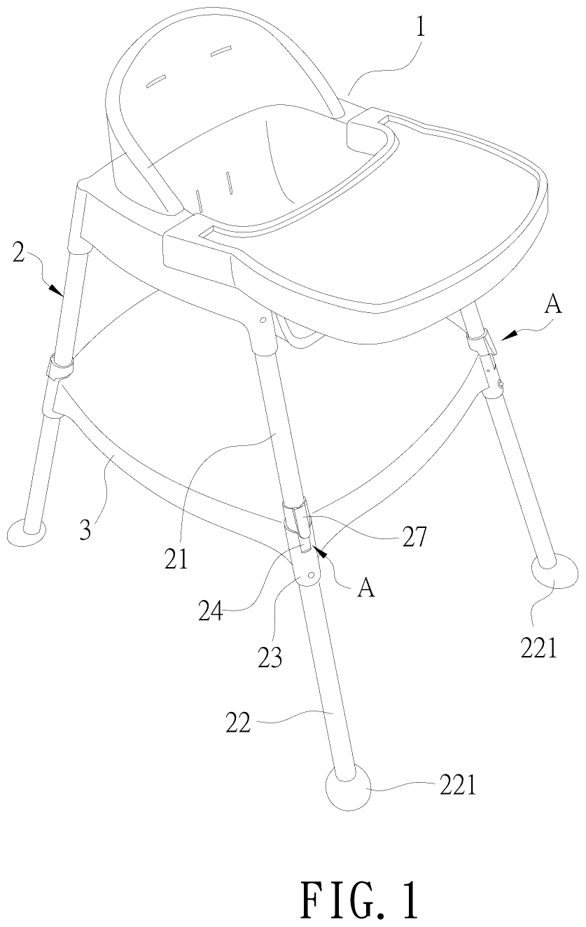

Refer to FIG. 1 to FIG. 3, an embodiment of a fastening member for quick release and fastening of a leg of a high chair according to the present invention is provided. The high chair includes a seat portion 1 and four legs 2 connected to four corners of the seat portion 1 correspondingly for supporting the seat portion 1 stably. Each of the legs 2 consists of an upper support tube 21, a lower support tube 22, and a fastening member A disposed between the upper support tube 21 and the lower support tube 22.

The fastening member A is composed of a sleeve member 23, a locking hook 24, a plug 25, a curved swing arm 26, and a sliding sleeve 27.

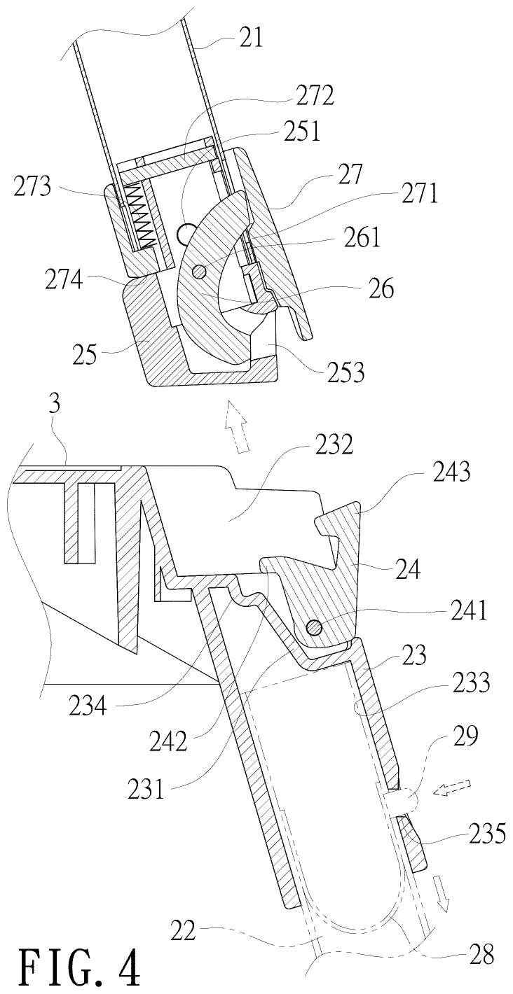

Also refer to FIG. 4, the sleeve member 23 is provided with an upper slot 232, a lower slot 233, a partition 231 for separating the upper slot 232 from the lower slot 233, and a step 234 disposed on the partition 231. A bottom end of the plug 25 is inserted in and connected to the upper slot 232 and an upper end of the lower support tube 22 is inserted in and connected to the lower slot 233.

One end of the locking hook 24 is connected to the upper slot 232 by a first pin 241 and able to rotate. The other end of the locking hook 24 is provided with a hook portion 243 and a middle portion of the locking hook 24 forms a projection 242 which is locked with the step 234 of the partition 231.

The plug 25 is fixed on a bottom end of the upper support tube 21 by a second pin 251 and provided with an upper opening 252 and a lower opening 253. Both the upper opening 252 and the lower opening 253 are communicating with an inner space of the plug 25 and the lower opening 253 is corresponding to the hook portion 243 of the locking hook 24.

The curved swing arm 26 is located in the inner space of the plug 25. A middle portion of the curved swing arm 26 is connected to the plug 25 by a third pin 261 and able to rotate. An upper part of the curved swing arm 26 is not only corresponding to both an insertion hole 211 penetrating a tube wall of the upper support tube 21 and the upper opening 252 but also protruding from the insertion hole 211 and the upper opening 252. A lower part of the curved swing arm 26 is inserted through the lower opening 253 of the plug 25 correspondingly.

The sliding sleeve 27 is mounted around a lower end of the upper support tube 21. By a reset part, the sliding sleeve 27 is connected to the upper support tube 21 and able to return to its original position. An abutting portion 271 is projecting from an inner wall of the sliding sleeve 27, corresponding to the insertion hole 211, and abutting against the upper part of the curved swing arm 26.

In this embodiment, the reset part includes a limit rod 272 and a spring 273. Two ends of the limit rod 272 are inserted in and disposed on a peripheral wall of the plug 25 and a step-like member 274 on a bottom of the sliding sleeve 27 is reaching into the upper support tube 21. Thus two ends of the spring 273 are abutting against the limit rod 272 and step-like member 274 on the bottom of the sliding sleeve 27 correspondingly.

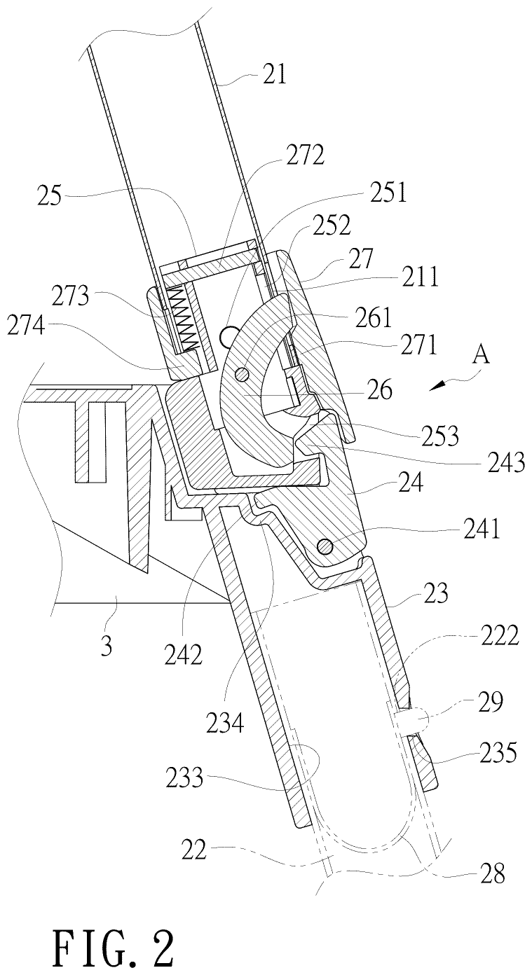

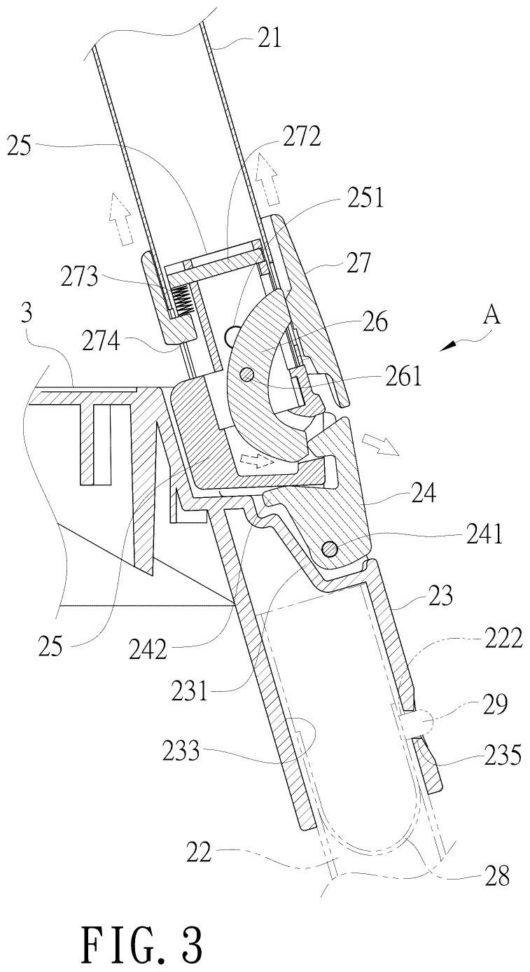

During fastening, as shown in FIG. 1 and FIG. 2, the sliding sleeve 27 is covering the locking hook 24 so that the locking hook 24 will not be released from a fastened state due to unintended touches. Once users need to release the fastening member A from the fastened state, refer to FIG. 2 and FIG. 3. Use the thumb and the index finger to grasp two sides of the sliding sleeve 27 and move the sliding sleeve 27 toward the direction indicated by dot-dashed arrows shown in FIG. 3. At the moment, the abutting portion 271 in the sliding sleeve 27 is abutting against the upper part of the curved swing arm 26. Thus the curved swing arm 26 is rotated around the third pin 261 toward the direction indicated by the dashed arrow shown in FIG. 3. Then the lower part of the curved swing arm 26 pushes the hook portion 243 of the locking hook 24 to rotate toward the direction indicated by the hollow arrow shown in FIG. 3. Thereby the hook portion 243 of the locking hook 24 is removed from the lower opening 253 of the plug 25 to be released from fastened state and the upper support tube 21 is separated from the lower support tube 22, as shown in FIG. 4. Next no force is applied to the sliding sleeve 27 so that the sliding sleeve 27 is returned to its original position due to a recovery force of the spring 273. Under such state, the abutting portion 271 of the sliding sleeve 27 is abutting against and in contact with the upper part of the curved swing arm 26.

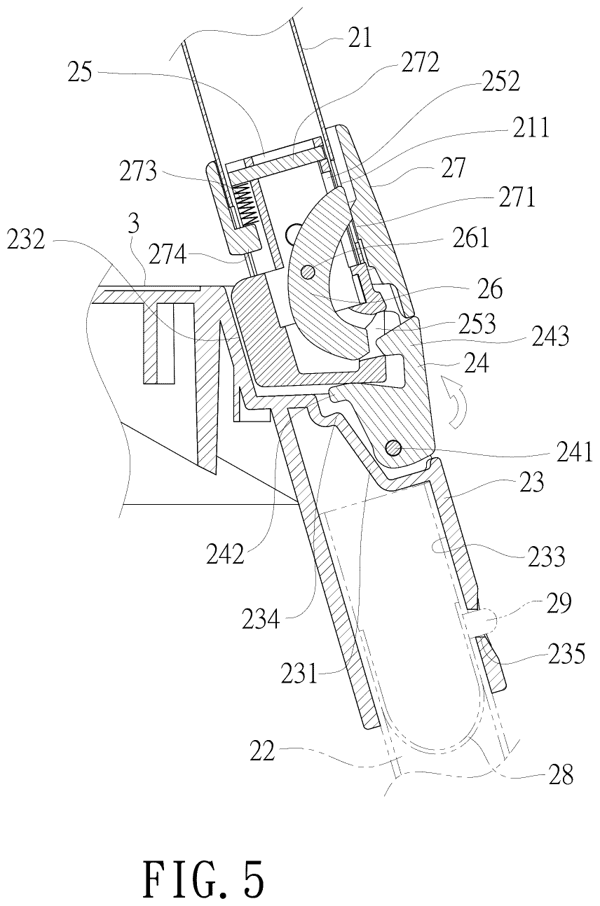

When the user intends to connect the upper support tube 21 with the lower support tube 22, the bottom end of the plug 25 is directly inserted into the upper slot 232 of the sleeve member 23. Now a bottom surface of the plug 25 is in contact with and pressing down the projection 242 of the locking hook 24 so that the locking hook 24 is rotated around the first pin 241 toward the direction indicated by the arrow in FIG. 5. Thus the hook portion 243 of the locking hook 24 is mounted into the lower opening 253 of the plug 25 to be in the fastened state. At the same time, the sliding sleeve 27 is covering the locking hook 24 for ensuring the fastened state of the locking hook 24.

In summary, by the arrangement of the fastening member A, the locking hook 24 already fastened is covered by the sliding sleeve 27 and unable to be released from the fastened state due to unintended touches of children or parents. Thus the upper support tube 21 connected with the lower support tube 22 will not separate from each other and the safety in use of the high chair is ensured. In an embodiment of the present invention, the high chair includes a table plate 3 which is located under the seat portion 1. Each of four corners of the table plate 3 is provided with the sleeve member 23. Thereby the high chair with the table plate 3 is formed and the table plate 3 is able to be separated from the seat portion 1.

In a preferred embodiment, a backrest of the seat portion 1 is filled with foamed plastic which has advantages of light weight, strong adsorption ability, non-shattering, good stain release ability, long service life, etc. In practice, other materials can also be used as stuffing filled in the backrest.

Refer to FIG. 1, in the embodiment, an anti-slip pad 221 is disposed on a bottom of the lower support tube 22 in order to prevent slipping.

Refer to FIG. 2, FIG. 3, and FIG. 4, a through hole 235 is arranged at the lower slot 233 of the sleeve member 23. A tube wall on one end of the lower support tube 22 inserted into the lower slot 233 of the sleeve member 23 is provided with an insertion hole 222 and a U-shaped spring 28 is mounted inside the lower support tube 22. One end of the U-shaped spring 28 is connected with a projection 29 inserted through the insertion hole 222 and elastically protruding from the tube wall of the lower support tube 22 to be locked in the through hole 235 correspondingly. Thereby the lower support tube 22 is inserted and fixed in the lower slot 233 of the sleeve member 23. Once the user intends to separate the sleeve member 23 from the lower support tube 22, the projection 29 is pressed into the through hole 235, without protruding from and locked in the through hole 235. Thus the lower support tube 22 is detached from the lower slot 233 of the sleeve member 23 directly. Therefore, the volume is reduced and space for storage and transportation is minimized.

Standard parts used in the present invention can be obtained on the market available now. Special shaped parts can be customized according to the specifications and the figures attached. The respective parts are connected by common ways including bolts, rivets, and welding of the techniques available now. Machines, parts, and equipment used are conventional models of the techniques available now. No more details are provided.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

It should be understood that although the present invention has been described in the specification by a plurality of embodiments, not each of the embodiments includes an independent technical solution. The purpose of the description is only to disclose the invention clearly. People skilled in the art should understand the invention based on a reading of the specification as a whole. The technical solutions in the respective embodiment can be combined to form other embodiments able to be understood by the people skilled in the art.

What is claimed is:

1. A fastening member for quick release and fastening of legs of a high chair comprising: a sleeve member, a locking hook, a plug, a curved swing arm, and a sliding sleeve; the high chair having a seat portion and the legs connected to four corners of the seat portion correspondingly; each of the legs having an upper support tube and a lower support tube and the fastening member disposed between the upper support tube and the lower support tube;
wherein the sleeve member includes an upper slot, a lower slot, a partition for separating the upper slot from the lower slot, and a step disposed on the partition; a bottom end of the plug is inserted in and connected to the upper slot and an upper end of the lower support tube is inserted in and connected to the lower slot;
wherein one end of the locking hook is connected to the upper slot by a first pin and able to rotate; the other end of the locking hook is provided with a hook portion and a middle portion of the locking hook forms a projection which is locked with the step of the partition;
wherein the plug is fixed on a bottom end of the upper support tube by a second pin and provided with an upper opening and a lower opening; the upper opening and the lower opening are communicating with an inner space of the plug and the lower opening is corresponding to the hook portion of the locking hook;
wherein the curved swing arm is located in the inner space of the plug; a middle portion of the curved swing arm is connected to the plug by a third pin and able to rotate; an upper part of the curved swing arm is not only corresponding to both an insertion hole penetrating a tube wall of the upper support tube and the upper opening, but also protruding from the insertion hole and the upper opening; a lower part of the curved swing arm is inserted through the lower opening of the plug correspondingly;
wherein the sliding sleeve is mounted around a lower end of the upper support tube; by a reset part, the sliding sleeve is connected to the upper support tube and able to return to its original position; an abutting portion is projecting from an inner wall of the sliding sleeve, corresponding to the insertion hole, and abutting against the upper part of the curved swing arm.

2. The fastening member for quick release and fastening of the legs of the high chair as claimed in claim 1, wherein the reset part includes a limit rod and a spring; two ends of the limit rod are inserted in and disposed on a peripheral wall of the plug and a step-like member on a bottom of the sliding sleeve is reaching into the upper support tube so that two ends of the spring are abutting against the limit rod and step-like member on the bottom of the sliding sleeve correspondingly.

3. The fastening member for quick release and fastening of the legs of the high chair as claimed in claim 2, wherein the high chair includes a table plate located under the seat portion and each of four corners of the table plate is provided with the sleeve member.

4. The fastening member for quick release and fastening of the legs of the high chair as claimed in claim 3, wherein a backrest of the seat portion is filled with foamed plastic.

5. The fastening member for quick release and fastening of the legs of the high chair as claimed in claim 4, wherein a through hole is arranged at the lower slot; a tube wall of the lower support tube is provided with an insertion hole and a U-shaped spring is mounted inside the lower support tube; one end of the U-shaped spring is connected with a projection inserted through the insertion hole and elastically protruding from the tube wall of the lower support tube to be locked in the through hole correspondingly.

6. The fastening member for quick release and fastening of the legs of the high chair as claimed in claim 1, wherein the high chair includes a table plate located under the seat portion and each of four corners of the table plate is provided with the sleeve member.

7. The fastening member for quick release and fastening of the legs of the high chair as claimed in claim 6, wherein a backrest of the seat portion is filled with foamed plastic.

8. The fastening member for quick release and fastening of the legs of the high chair as claimed in claim 7, wherein a through hole is arranged at the lower slot; a tube wall of the lower support tube is provided with an insertion hole and a U-shaped spring is mounted inside the lower support tube; one end of the U-shaped spring is connected with a projection inserted through the insertion hole and elastically protruding from a tube wall of the lower support tube to be locked in the through hole correspondingly.

9. The fastening member for quick release and fastening of the legs of the high chair as claimed in claim 1, wherein a backrest of the seat portion is filled with foamed plastic.

10. The fastening member for quick release and fastening of the legs of the high chair as claimed in claim 9, wherein a through hole is arranged at the lower slot; a tube wall of the lower support tube is provided with an insertion hole and a U-shaped spring is mounted inside the lower support tube; one end of the U-shaped spring is connected with a projection inserted through the insertion hole and elastically protruding from a tube wall of the lower support tube to be locked in the through hole correspondingly.
